(19) United States
(12) Patent Application Publication
(10) Pub. No.: US 2025/0169631 A1
(43) Pub. Date: May 29, 2025

(54) Memory Foam Pillow for Side Sleepers and Manufacturing Process and Device

(71) Applicant: Bradley Ray Newman, Scottsdale, AZ (US)

(72) Inventor: Bradley Ray Newman, Scottsdale, AZ (US)

(21) Appl. No.: 18/518,498

(22) Filed: Nov. 23, 2023

(51) Int. Cl. A47G 9/10

(52) U.S. Cl. CPC A47G 9/1081; A47G 2009/1018

(57) ABSTRACT

The present invention provides an ergonomic memory foam pillow, a manufacturing device for producing such pillows, and an associated method. The device includes two plates, each with aligned cutting slots and alignment pins, supported by a structure allowing one plate to move over a fixed plate. The manufacturing method involves placing memory foam between the plates, aligning, and then cutting the foam into pillows with minimal waste. The resulting pillow features a trapezoidal shape, conducive to side sleepers, with the potential for a beveled edge to fit the shoulder curve, and can be rolled up for easy transport with a travel roll cover.

### FIELD OF INVENTION

The present invention relates generally to sleep support devices, specifically to an improved memory foam pillow and a manufacturing device for producing such pillows.

### BACKGROUND

In the field of sleep ergonomics, the traditional pillow design, often referred to as a “sack” style, has been the standard for a considerable time. These conventional pillows fail to provide adequate support for side sleepers, particularly during the deep sleep phase. The lack of support provided by a sack style pillow as the body fully relaxes into deep sleep can lead to misalignment of the head, neck and back, contributing to stress on the spine, back, and hips, and consequently disrupting the quality of rest causing the user to wake up and readjust multiple times during the night.

The conventional manufacturing processes for memory foam pillows are predominantly centered around molding techniques, which, while effective in producing uniform products, come with a set of significant drawbacks. The molding process is inherently capital intensive, requiring substantial investment in molds, specialized machinery, and setup costs. This high level of initial expenditure can be a substantial barrier for smaller manufacturers or those seeking to introduce innovative products to the market.

Additionally, molded pillows are typically produced in predetermined sizes and shapes, limiting the ability to offer customized support for individuals with specific needs, such as side sleepers. This one-size-fits-all approach may not adequately address the ergonomic requirements for different body types and sleep postures.

Furthermore, the rigidity of the molding process means that any design modification necessitates the creation of a new mold, which is not only costly but also time-consuming. This lack of flexibility in the manufacturing process hinders rapid prototyping and the ability to iterate on design enhancements, thereby slowing down the pace of innovation.

The traditional cutting techniques, which are an alternative to molding, also present challenges when working with memory foam. The material's consistency, akin to that of a soft, spongy cake, makes it particularly challenging to achieve clean and precise cuts. The process typically generates substantial waste, as the material removed to shape the pillow cannot be easily repurposed or recycled, leading to inefficiencies, environmental concerns and increased production costs.

It is within this context that the present invention is provided.

### SUMMARY

The present invention relates to a pillow and a manufacturing device for producing such pillows from memory foam. The invention includes a device for cutting memory foam that comprises a first plate and a second plate, each plate being flat and rectangular, with the first plate configured to be movably supported and the second plate configured to be fixed. The device contains a plurality of cutting slots within each plate, alignment pins for positioning the plates, a support structure for stability, and a cutting mechanism for consistently slicing the foam into pillow shapes.

The process of manufacturing carried out using the device involves placing a slab of memory foam atop the second lower plate, lowering the first upper plate on top of the slab, using the alignment pins to position the first plate with respect to the second plate, and making cuts through pairs of respective cutting slots of the first and second plate using the cutting mechanism, thereby cleanly cutting the slab of memory foam into a number of individual pillows of a desired shape with little to no waste material.

In some embodiments, the cutting mechanism is integrated within the device and may include an electric knife, while in other embodiments, it is a separate component designed for manual operation. The cutting slots facilitate angled cuts, which can be adjusted between vertical and 45 degrees, allowing for the creation of pillows with various edge shapes and configurations.

In further embodiments, the device is equipped with bolt studs or other suitable stud material to secure the foam during cutting. The first plate may be movably supported by a suspension system, while the support structure can include a frame for removably securing the plates. The alignment pins and cutting slots may be designed to be reconfigurable or offset from the first plate to the second plate, enabling the production of multiple pillow shapes without the need for changing plates. The device can operate in an automated mode, and the transparent material of the plates aids in aligning the foam and visualizing the cutting process.

Additionally, the invention encompasses a pillow manufactured from a single piece of memory foam, featuring a trapezoidal shape with a shoulder pocket design, defined as the physical space in and around the intersection of the neck and shoulder closest to the sleeping surface when a side sleeper is lying on one's side. The pillow is structured to be rolled up or otherwise compressed for convenience in transportation, using a travel cover, defined as a device used to secure the pillow in a compressed configuration for convenient transport.

In certain embodiments, the pillow includes a beveled front edge and curved cuts to conform to the user's neck and shoulder, enhancing comfort for side sleepers as they move from side to side while sleeping.

The above defined embodiments may also accommodate the use of CPAP devices and support the cervical spine for reduced wrinkles and minimal impact on cosmetic makeup, beneficial for users recovering from facial surgery.

The pillow's rollable structure and associated travel cover are designed for easy transport. The memory foam used is selected for its ability to be cut into the described shapes efficiently, minimizing waste during production, and its ability to repeatedly retain its original shape after being compressed multiple times. This summary encapsulates the principal components and technical attributes of the invention, providing a clear understanding of its construction and functionality.

### BRIEF DESCRIPTION OF THE DRAWINGS

Various embodiments of the invention are disclosed in the following detailed description and accompanying drawings.

FIG. 1 illustrates a woman sleeping on her side, comparing the spinal alignment with a conventional pillow and the improved support provided by the inventive pillow.

FIG. 2A depicts an example pillow of the present invention with a straight edge configuration.

FIG. 2B shows an example pillow of the present invention with a beveled edge configuration.

FIG. 3A presents a side view of an example manufacturing device for cutting memory foam, including a foam slab positioned for processing.

FIG. 3B provides a top view of the upper plate of the manufacturing device, detailing the cutting slot arrangement.

FIG. 3C provides a top view of the lower plate of the manufacturing device, detailing the cutting slot arrangement.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The terms “first,” “second,” and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

### DESCRIPTION OF DRAWINGS

The present disclosure pertains to a pillow specifically designed for side sleepers and a manufacturing device for producing such pillows from slabs of memory foam. The invention aims to address and rectify the limitations associated with traditional pillow manufacturing processes and the ergonomic shortfalls in current pillow designs.

The manufacturing device comprises a first and a second plate, each possessing cutting slots and alignment pins to facilitate the precise cutting of memory foam into pillows. The device is constructed to allow for the memory foam slab to be positioned and secured between the two plates, whereupon the cutting mechanism can effectuate the cutting process. The plates are designed to support a variety of cutting patterns, enabling the production of pillows with multiple shapes and features suited to the ergonomic requirements of side sleepers specifically, and other types of sleepers generally.

The pillow produced by this device is formed from a single piece of memory foam and incorporates a shape that supports the neck, spine, and shoulder alignment. It is further characterized by its ability to be rolled or otherwise compressed and enclosed within a travel cover, enhancing its portability. The design allows for features such as bevelled edges and contoured cuts, which are intended to provide targeted support to the user.

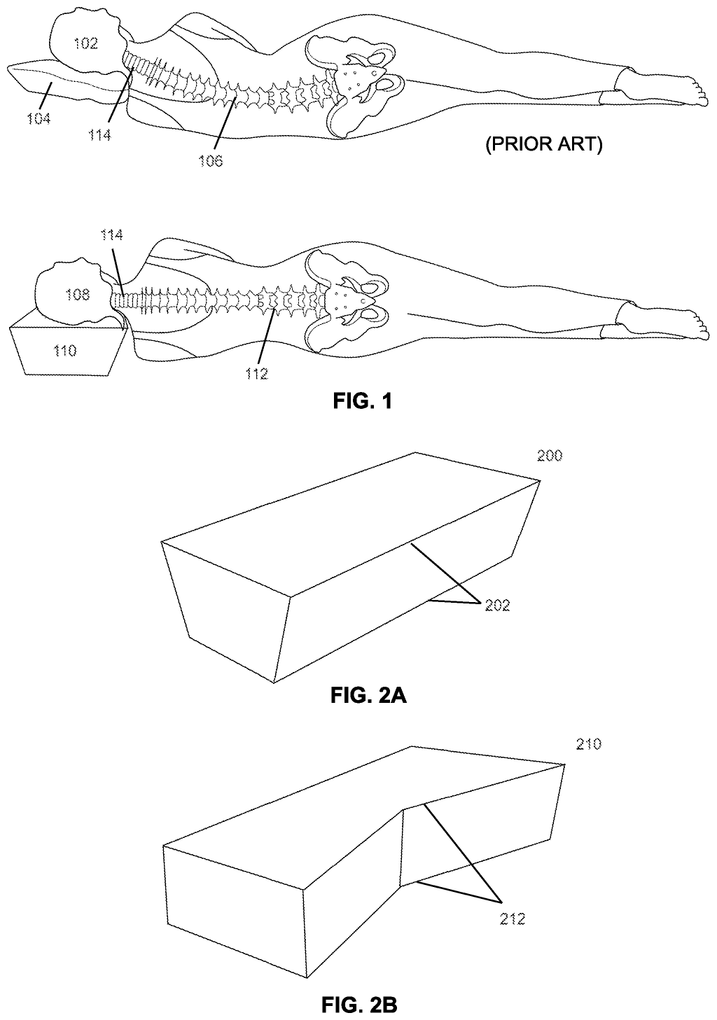

FIG. 1 presents a comparative illustration demonstrating the impact of pillow design on spinal alignment for a side sleeper.

The upper portion of FIG. 1 displays a side view of a woman 102 sleeping on a conventional sack-style pillow 104. Here, the woman's spine 106 is visibly misaligned, indicating a lack of adequate support. The sack-style pillow 104, due to its uniform height and lack of contouring, fails to accommodate the shoulder's breadth, resulting in the downward bend of the neck 114 and spine 106.

The lower portion of FIG. 1 shows the same woman 108 lying on a trapezoidal shaped memory foam pillow 110, representative of the current invention. In contrast to the upper image, the spine 112 of the woman is in a state of proper alignment, as the pillow provides the necessary support for the head, neck, shoulder, and back.

The figure highlights the differences in support provided by the two pillow types. The sack-style pillow 104 allows the woman's neck 114 to bend downward due to insufficient support, leading to a curved spinal posture as the woman's musculature fully relaxes into deep sleep. This misalignment results in varied levels of pain at the head, neck, shoulder, back and hips resulting in multiple reawakenings during the night to readjust her sleep position to alleviate the pain. Conversely, the pillow of the invention 110 supports the woman's neck 116 at a height that maintains the spine 112 in a neutral, straight alignment as the woman's musculature fully relaxes into deep sleep, consistent with the natural lateral position of a side sleeper. This proper alignment results in less pain at the head, neck, shoulder, back and hips resulting in longer durations of sleep between awakenings throughout the night.

FIG. 2A and FIG. 2B provide profile views of two variations of the memory foam pillow, illustrating the differences in edge design.

FIG. 2A depicts a memory foam pillow 200 with a straight edge. This embodiment showcases a pillow in its simplest form, with a uniform thickness throughout its length. The straight edge 202 of the pillow 200 is slanted with respect to the pillow's upper and lower surfaces, forming an approximately 70-degree angle at the junction of the edge 202 and the surfaces.

FIG. 2B illustrates a memory foam pillow 210 with a bevelled edge. The bevelled edge 212 is similarly slanted at an angle of approximately 70 degrees, creating an inclined surface that transitions between the upper and lower surfaces of the pillow 210. This bevel 212 is designed to conform to the specific contours of a user's body when in use, such as accommodating side to side movement of the shoulder and neck area for side sleepers as they sleep.

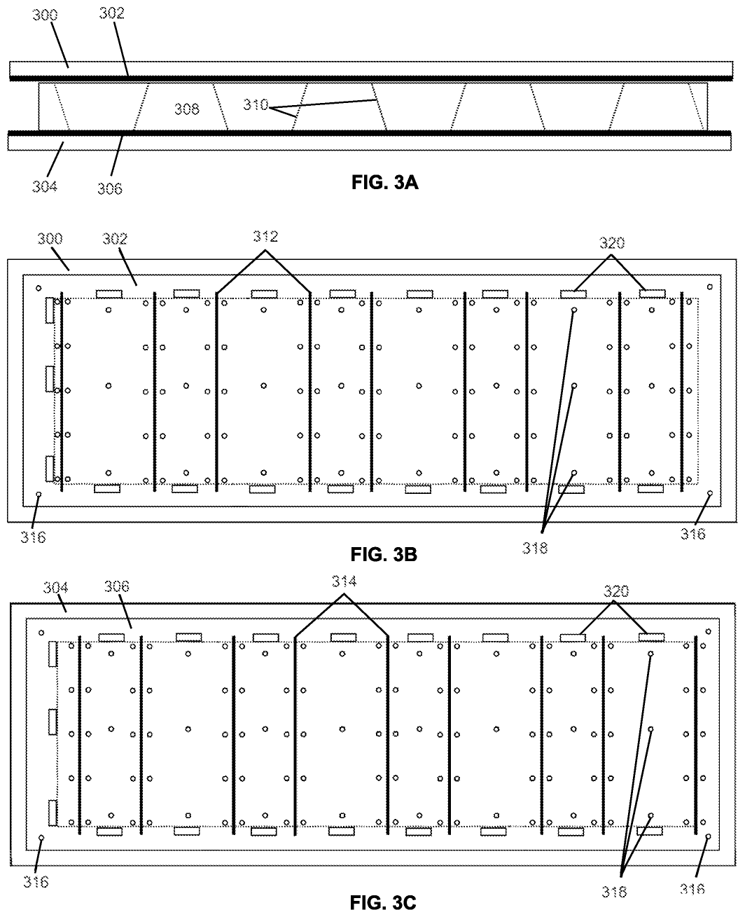

FIG. 3A illustrates a side profile view of an example configuration of the memory foam cutting manufacturing device, specifically detailing the arrangement of a foam slab ready for processing. This device includes an upper frame 300 holding an upper plate 302 and a lower frame 304 holding a lower plate 306. A slab of memory foam 308 is placed between the upper plate 302 and the lower plate 306, with dashed lines 310 indicating the path of the angled cuts to be made through the cutting slots in the plates to create individual pillows of a desired shape.

FIG. 3B and FIG. 3C present top-down views of the upper plate 302 and lower plate 306 respectively.

In FIG. 3B, the upper plate 302 is shown within the upper frame 300 of the manufacturing device. The upper plate 302 displays a series of cutting slots 312, which align to create desired angles with corresponding cutting slots 314 in the lower plate (shown in FIG. 3C) when the two plates are positioned over one another. These slots 314 are designed to accommodate and guide a cutting device which, when passed through, uniformly slices the memory foam slab into the final pillow product.

The plates may be constructed from plexi-glass or other suitable material such as glass or polycarbonate material, chosen for its rigidity and clarity, allowing for precise alignment of the foam slab during the cutting process. Alignment pins 316 ensure the upper and lower plates are correctly positioned to match the cutting slots for accurate cuts.

The manufacturing device also includes bolt studs 318 on both the upper and lower plates to secure the foam slab during cutting, for maintaining the foam in a fixed position, which is particularly important when dealing with the inherently pliable nature of memory foam. Alternately, all or portions of the foam 308 can be secured in place for cutting with long, thin, rigid pins that extend vertically through the upper plate 302, through the memory foam 308 and through the lower plate 306.

A set of alignment guides 320 are also included on both plates to assist user's in performing manual alignment of the two plates, though these may not be necessary for automated versions of the device.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the pillow and manufacturing device and process have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A device for cutting memory foam, comprising:
a first plate and a second plate, each plate comprising:
a flat surface formed of a rigid material;
a plurality of cutting slots disposed along the flat surface, and which are arranged to align with each other at desired angles when the first plate is positioned over the second plate; and
a plurality of alignment pins configured to position the first plate in relation to the second plate;
a support structure configured to maintain the second plate in a fixed positioned beneath the first plate and to moveably support the first plate with respect to the second plate.

2. The device of claim 1, wherein the support structure for the first and second plates includes an upper frame and a lower frame into which each plate is removably secured.

3. The device of claim 1, further comprising a cutting mechanism configured to traverse the cutting slots of the first and second plates to cut a slab of memory foam placed between the plates.

4. The device of claim 3, wherein the cutting mechanism is integrated with the device.

5. The device of claim 3, wherein the cutting mechanism is a separate component operable to be manually manipulated through the cutting slots.

6. The device of claim 1, wherein the plurality of cutting slots comprise a combination of straight and curved slots to create various pillow shapes.

7. The device of claim 1, further comprising one or more pinning elements positioned on at least one of the first plate and the second plate, the pinning elements being configured to hold the memory foam slab in place during the cutting process.

8. The device of claim 1, wherein the first plate is movably supported by a suspension system.

9. The device of claim 1, wherein the first and second plates are composed of a transparent material.

10. A method for manufacturing pillows from a slab of memory foam, the method comprising the steps of:
providing a first movably supported flat plate and a second fixedly supported flat plate;
positioning a slab of memory foam on the second plate;
lowering the first plate onto the slab of memory foam;
aligning the first plate with the second plate using a plurality of alignment pins; and
cutting the slab of memory foam into individual pillows by passing a cutting mechanism through pairs of respective cutting slots in the first and second plates.

11. The method of claim 1, further comprising adjusting the angle of the cuts made by the cutting mechanism between vertical and 45 degrees to create pillows with varied edge configurations.

12. The method of claim 1, further including the step of securing the slab of memory foam with pinning elements during the cutting process to prevent movement of the foam.

13. A pillow formed of a single piece of cut memory foam, and comprising a body with a trapezoidal shape to form a shoulder pocket design when in use.

14. The pillow of claim 13, wherein the pillow is structured to be compressed into a compact form for insertion into a travel cover.

15. The pillow of claim 13, wherein the trapezoidal shape includes a beveled front edge to accommodate the curvature of a user's shoulder.

16. The pillow of claim 13, further comprising a travel cover with fastening means to maintain the pillow in a compressed configuration.
